(19) United States
(12) Patent Application Publication
(10) Pub. No.: US 2024/0024967 A1
(43) Pub. Date: Jan. 25, 2024

(54) MODULAR CUTTING TOOL

(71) Applicant: Kennametal Inc., Latrobe, PA (US)

(72) Inventors: Marcelo Euripedes da Silva, Piracicabo (BR); Ruy Frota de Souza Filho, Latrobe, PA (US); Patrick Kuhlemann, Fuerth (DE); Michael Schuffenhauer, Fuerth (DE)

(73) Assignee: Kennametal Inc., Latrobe, PA (US)

(21) Appl. No.: 17/868,991

(22) Filed: Jul. 20, 2022

(51) Int. Cl. B23B 51/02

(52) U.S. Cl. CPC B23B 51/02

(57) ABSTRACT

A modular cutting tool includes a base body, an intermediate body removably attached to the base body, and a cutting head at least partially disposed within a pocket of the intermediate body. A tooling tree allows a user to select a different combination of the base body, the intermediate body and the cutting head of the cutting tool based on desired physical properties of each component.

### FIELD OF THE DISCLOSURE

In general, the disclosure relates to cutting tools for performing machining operations on a workpiece, and more particularly, to a modular cutting tool that allows the user to select combinations of the various components of the cutting tool based on the required application of the cutting tool.

### BACKGROUND OF THE DISCLOSURE

Conventional cutting tools can be of both one-part and multi-part design. Cutting tools of the type that make use of a holder part or tool body, as well as a separate, replaceable cutting head or insert, are especially common and are known as a modular cutting tool. Such modular cutting tools may be of widely varying shapes and include, for example, drilling tools, milling tools, thread cutters, and the like.

Typically, the modular rotary cutting tool, such as a drill, is made of a main body with a replaceable carbide cutting head or cutting insert. This configuration allows the user to save money by replacing the carbide cutting head several times before replacing the main body, typically made of steel. However, one limitation of this configuration is the need to replace the main body with a different main body in order to change the physical properties, such as length, material, and the like, of the modular drill.

### SUMMARY OF THE DISCLOSURE

The problem of changing the configuration of a modular rotary cutting tool is solved by providing a modular cutting tool comprising a base body and an intermediate body removably attached to the base body for supporting a replaceable cutting head. The base body, the intermediate body and the cutting head can be selected by a user using a tooling tree.

In one aspect, a modular cutting tool comprises a base body; an intermediate body removably attached to the base body; and a cutting head at least partially disposed within a pocket of the intermediate body, wherein a tooling tree allows a user to select a different combination of the base body, the intermediate body and the cutting head of the cutting tool.

### BRIEF DESCRIPTION OF THE DRAWINGS

While various embodiments of the disclosure are illustrated, the particular embodiments shown should not be construed to limit the claims. It is anticipated that various changes and modifications may be made without departing from the scope of this disclosure.

FIG. 1 is an elevational view of a cutting tool that includes a base body, an intermediate body and a cutting head according to an embodiment of the invention;

FIG. 2 is an exploded elevational view of the cutting tool of FIG. 1;

FIG. 3 is a partial, enlarged, exploded elevational view showing a method of attaching the intermediate body to the base body;

FIG. 4 is a partial, enlarged, exploded elevational view of the base body, the intermediate body and the cutting head showing an alternate method of attaching the intermediate body to the base body;

FIG. 5 is a plan view of the intermediate body of the cutting tool of FIG. 1;

FIG. 6 is an elevational view of the intermediate body of the cutting tool of FIG. 1;

FIG. 7 is an elevational view of the cutting head of the cutting tool of FIG. 1;

FIG. 8 is a plan view of the cutting head of the cutting tool of FIG. 1;

FIG. 9 is an elevational view of the cutting head and setscrew according to an embodiment of the invention;

FIG. 10 is an elevational view of the intermediate body and the cutting head mounted in the pocket of the intermediate body; and

FIG. 11 is an example of a tooling tree showing the various combinations of the base body, the intermediate body and the cutting head that can be selected by the user.

### DETAILED DESCRIPTION OF THE DISCLOSURE

It will be readily understood that the components of embodiments, as generally described and illustrated in the figures herein, may be arranged and designed in a wide variety of different configurations in addition to the described exemplary embodiments. Thus, the following more detailed description of the embodiments, as represented in the figures, is not intended to limit the scope of the embodiments, as claimed, but is merely representative of exemplary embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments. One skilled in the relevant art may well recognize, however, that embodiments can be practiced without at least one of the specific details thereof, or can be practiced with other methods, components, materials, et cetera. In other instances, well-known structures, materials, or operations are not shown or described in detail to avoid obscuring aspects of one or more embodiments.

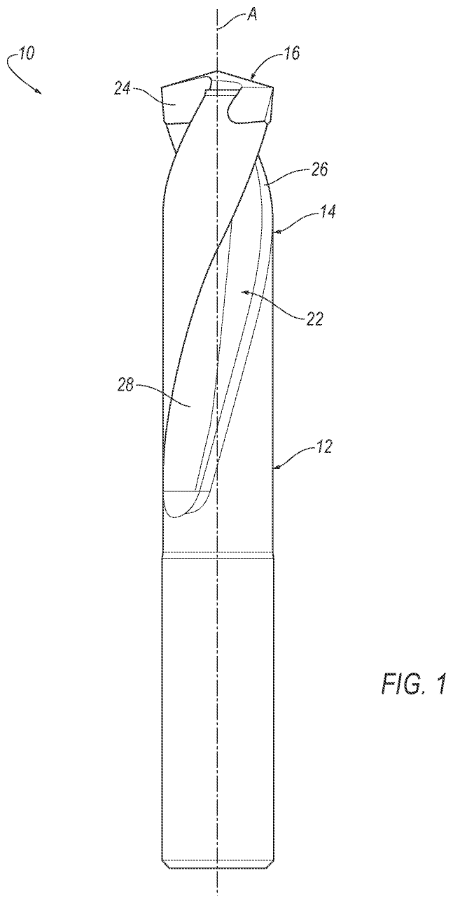

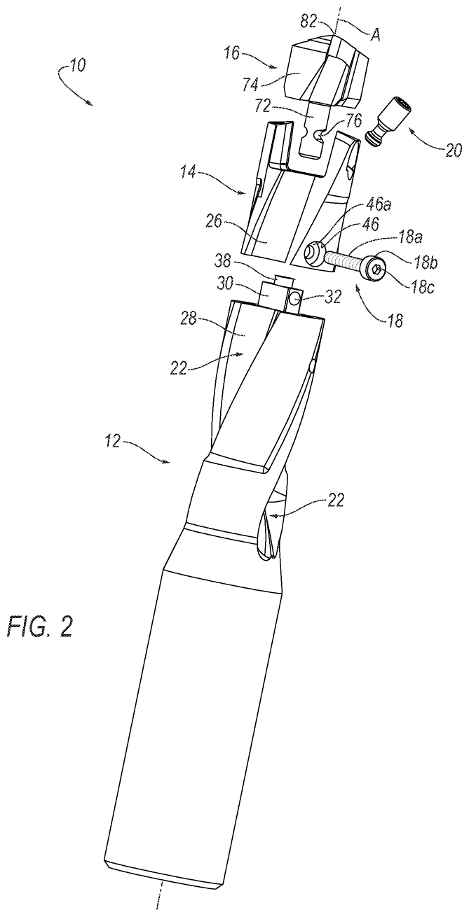

Referring now to FIGS. 1 and 2, a cutting tool 10 is shown according to an embodiment of the invention. In general, the cutting tool 10 has four basic components:
1) a base body 12;
2) an intermediate body 14;
3) a cutting head or cutting insert 16; and
4) a threaded fastener 18.

All four basic components are produced as separate parts. The intermediate body 14 can be fastened to, or installed on, the base body 12 in a detachable and interchangeable manner using the threaded fastener 18. Similarly, the cutting head 16 can be fastened to, or installed on, the intermediate body 14 in a detachable and interchangeable manner using, for example, a setscrew 20. For purely illustrative purposes, the cutting tool 10 comprises a twist drill that includes a pair of helical flutes 22 disposed along the sides of the cutting tool 10, in diametric opposition to one another. Each flute 22 extends over a base body 12, the intermediate body 14 and the cutting head 16. However, it should be appreciated that the cutting tool 10 can also be designed as a countersinking, milling, or reaming tool.

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this disclosure pertains.

For purposes of this specification (other than in the operating examples), unless otherwise indicated, all numbers expressing quantities and ranges of ingredients, process conditions, etc., are to be understood as modified in all instances by the term “about”. Accordingly, unless indicated to the contrary, the numerical parameters set forth in this specification and attached claims are approximations that can vary depending upon the desired results sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

As used herein, the term “elongate” or “elongated” is defined as something that is longer than it is wide. In other words, the width is smaller than its length.

As used herein, a “threaded fastener” is defined as a fastener having a tapered or non-tapered shank with a helical thread and is driven by rotating the shank with a tool.

As used herein, a “physical property” is defined as a characteristic of matter that can be observed and measured. The two classes of physical properties are intensive and extensive properties. An intensive property is a characteristic of the material regardless of how much matter is present. On the other hand, an extensive property depends on sample size. Examples of intensive properties include, but is not limited to, temperature, color, melting point, boiling point, and density. Examples of extensive properties includes, but is not limited to, length, shape, density, volume, and mass.

Generally, a central, longitudinal axis, A, is defined through the cutting tool 10 (common to both the base body 12, the intermediate body 14 and the cutting head 16), about which the cutting tool 10 rotates during operation. A “cutting head” may alternatively be referred to, herein and elsewhere, with any of a variety of other suitable terms such as “tip”, “insert”, “cutting tip”, or “cutting insert”.

As shown in FIGS. 1 and 2, two flutes 22 are provided in diametric opposition to one another with only one flute being visible in some drawings. It should be noted that each flute 22 includes portions that are disposed in the base body 12, the intermediate body 14 and the cutting head 16. Specifically, each flute 22 has a lateral recess forming part of a flute or cutting head flute portion 24 formed in cutting head 16. A corresponding or complementing lateral recess or intermediate body flute portion 26 is formed in the intermediate body 14. Similarly, a corresponding or complementing lateral recess or base body flute portion 28 is formed in the base body 12. Thus, once the intermediate body 14 is installed on the base body 12 and the cutting head 16 is installed on the intermediate body 14, the corresponding portions of the flute 22 in the base body 12, the intermediate body 14 and the cutting head 16 will align to form flutes that are generally continuous and undistorted. Although two flutes 22 are depicted herein, it should be understood that any number of flutes 22 (including only one) is possible, depending on the physical dimensions of the cutting tool 10.

In the depiction of FIG. 2, the cutting head flute portion 24 emerges at a leading end of the cutting tool 10. The leading end is defined for semantic purposes and is that end that engages a work piece (not shown) during a cutting operation. During cutting operations, the cutting tool 10 is mounted in the rotary cutting tool, rotated, and advanced progressively into the work piece (not shown) as cutting progresses. That end of the cutting head 16 opposite the leading end is termed the trailing end. The terms “leading end” and “trailing end” are semantic devices that apply equally to the base body 12 and the intermediate body 14 as they connote directional orientation with respect to a central, longitudinal axis, A, rather than specific structure. The leading end penetrates a work piece (not shown), and the trailing end is that end opposed to the leading end.

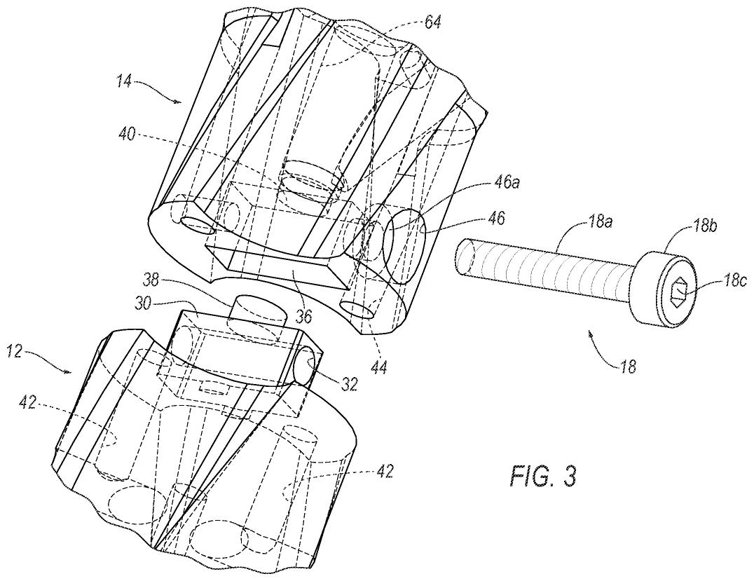

Referring now to FIG. 3, one aspect of the invention is that the leading end of the base body 12 includes a raised boss 30 extending axially upward toward the trailing end of the intermediate body 14. In the illustrated embodiment, the raised boss 30 has a threaded aperture 32 for receiving the threaded fastener 18, such as a screw, bolt, and the like. The threaded fastener 18 has a threaded shaft portion 18a and a non-threaded head portion 18b having a relatively larger diameter than the threaded shaft portion 18a. As is known in the art, the threaded fastener 18 has a recess 18c for allowing a tool (not shown), such as an Allen® wrench, and the like, to rotate the threaded fastener 18.

The raised boss 30 is capable of being received within a cavity 36 formed in the trailing end of the intermediate portion 14. In the illustrated embodiment, the raised boss 30 has a geometric shape that is complementary to the geometric shape of the cavity 36. For example, the raised boss 30 and the cavity 36 can be circular, polygonal, or any desired complimentary geometric shape. In the illustrated embodiment, for example, the raised boss 30 and the cavity 36 are substantially rectangular in shape to adequately support the torque generated during a cutting operation. The raised boss 30 may include a pilot 38 that is capable of being received in a pilot hole 40 in the intermediate body 14 for assisting in alignment between the base body 12 and the intermediate body 14.

As shown in FIG. 3, the base body 12 has one or more coolant holes 42 that extend entirely from the trailing end of the base body 12 to the leading end of the base body 12. In addition, the intermediate body 14 includes one or more coolant holes 44 that extend entirely from the trailing end of the intermediate body 14 to the leading end of the intermediate body 14. It should be understood that the coolant holes 42, 44 are substantially aligned with each other when the raised boss 30 of the base body 12 is properly received within the cavity 36 of the intermediate body 14, thereby allowing coolant to be supplied from the trailing end of the base body 12, through the intermediate body 14, and to the cutting head 16 of the cutting tool 10. In addition, the intermediate body 14 includes an aperture 46 capable of receiving the shaft portion 18a of the threaded fastener 18. The aperture 46 has a stop surface 46a that abuts the head portion 18b of the threaded fastener 18 to prevent unwanted radial movement of the threaded fastener 18.

Removably attaching the intermediate body 14 to the base body 12 can be accomplished in a simple manner by inserting the raised boss 30 of the base body 12 into the cavity 36 of the intermediate body 14. The pilot 38 of the base body 12 can be used as a guide to properly align the base body 12 and the intermediate body 14 when inserting the raised boss 30 into the cavity 36. Once the raised boss 30 is properly inserted into the cavity 36, the threaded fastener 18 is then threaded into the threaded aperture 32 in the raised body 30 to securely and removably attach the intermediate body 14 to the base body 12.

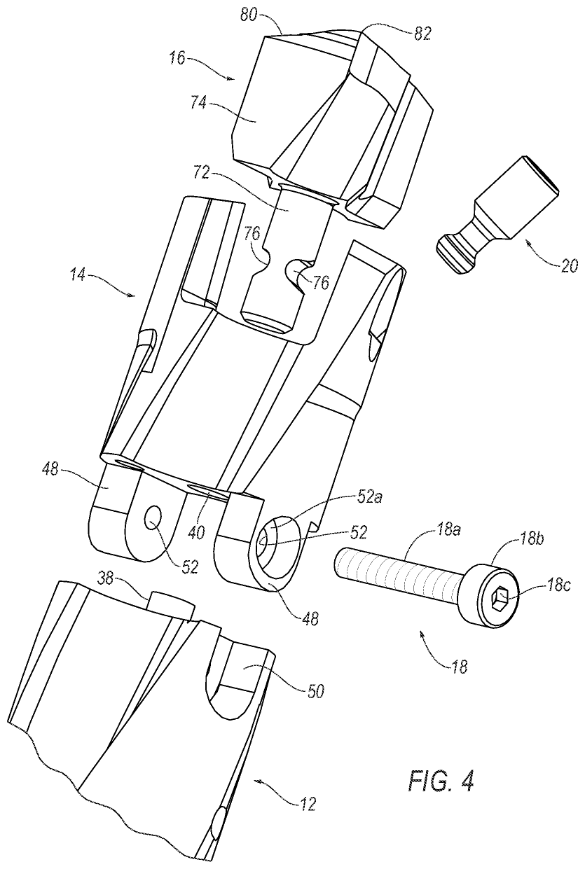

It should be appreciated that the intermediate body 14 can be removably attached to the base body 12 in a variety of acceptable methods. Referring now to FIG. 4, for example, the intermediate body 14 can be removably attached to the base body 12 using a pair of downwardly extending ears 48 formed on opposite sides of the intermediate body 14 that cooperate with a pair of compatible-shaped recesses 50 formed on opposite sides in the base body 12. One or both ears 48 may include a aperture 52 that is capable of receiving the threaded fastener 18. In the illustrated embodiment, for example, the ear 48 on the left (as viewed in FIG. 4) has a aperture 52.

Again, removably attaching the intermediate body 14 to the base body 12 can be accomplished in a simple manner by inserting the pilot 38 of the base body 12 into the pilot hole 40 formed in the intermediate body 14. Simultaneously, the ears 48 of the intermediate body 14 are receiving with a respective recess 50 formed in the base body 12. Then, the threaded fastener 18 is threaded into at least one of the apertures 52 until the intermediate body 14 is securely and removably attached to the base body 12. Similar to the embodiment shown in FIG. 3, at least one of the apertures 52 has a stop surface 52a that abuts the head portion 18b of the threaded fastener 18 for preventing the unwanted radial movement of the threaded fastener 18 when threading the threaded fastener 18 into the apertures 52.

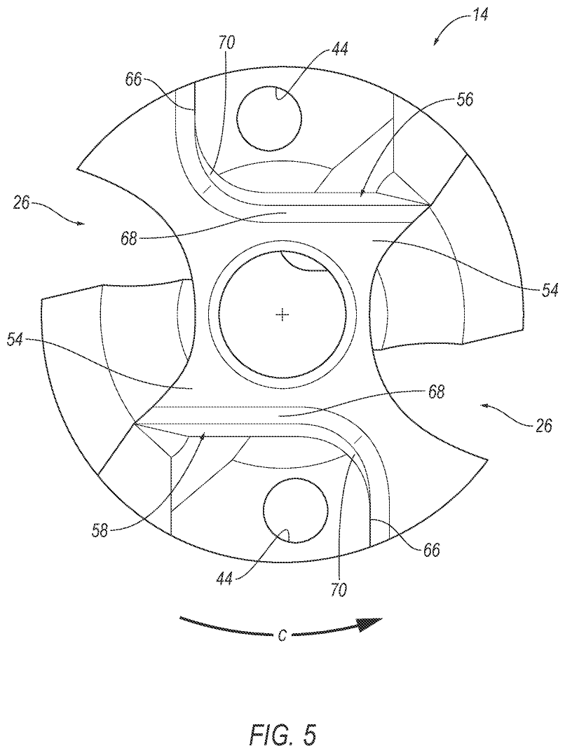

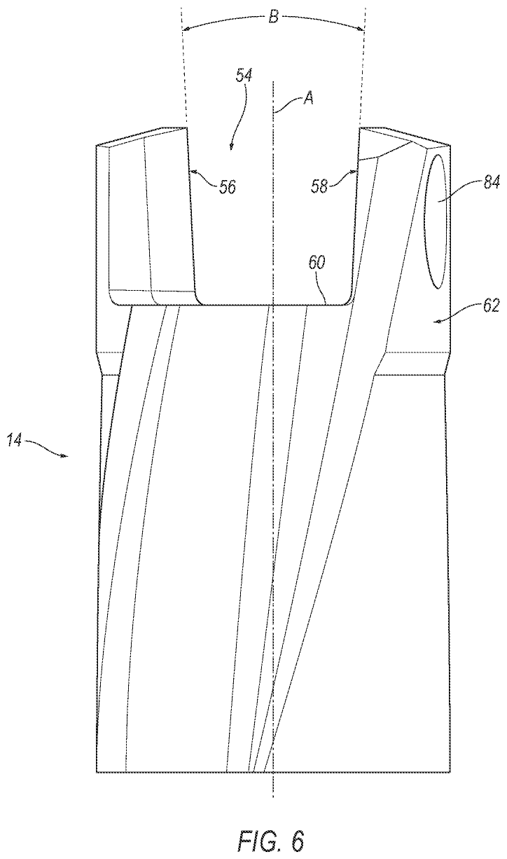

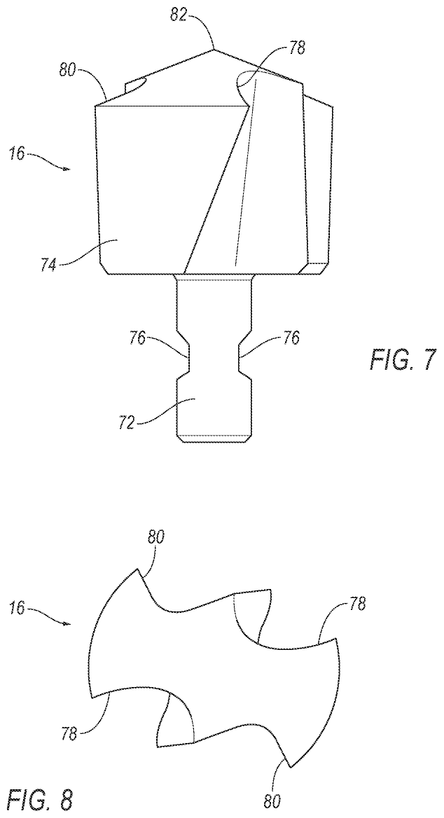

Referring now to FIGS. 5 and 6, the intermediate body 14 includes a pair of intermediate body flute portions 26 that are configured to interface with compatible cutting head flute portions 24 of the cutting head 16 (FIG. 1). The portion of the intermediate body 14 that couples to and rotates the cutting head 16 is referred to as a pocket 54. The principal elements of the pocket 54 include two generally symmetrical and similar castellated wall sections 56, 58. It should be understood that wall section 58 is a generally symmetrical counterpart of the wall section 56, and therefore only wall section 56 will be described for brevity. Each wall section 56, 58 is essentially a continuation of the intermediate body 14 that projects upwardly from a central floor portion 60 of the intermediate body 14 along the outer periphery of intermediate body 14. The central floor portion 60 can be oriented transversely with respect to the central longitudinal axis, A. Any or all of the central floor portion 60 and the wall sections 56, 58 serve as abutment surfaces that contact the cutting head 16 when the cutting head 16 is installed on the intermediate body 14. Each wall section 56, 58 has a smooth outer surface 62 that conforms to and is generally coextensive with the generally cylindrical outer surface of the cutting tool 10. A bore 64 extends downward from the central floor portion 60 of the tool body 12 for accommodating a coupling pin 72 (FIGS. 7-9) of the cutting head 16.

It should be appreciated that the wall sections 56, 58 deform to receive compatible portions of the cutting head 16 by means of an interference fit. As shown in FIG. 6, the wall sections 56, 58 can be inclined symmetrically with respect to the central longitudinal axis, A, and at a mutual non-zero angle, B, with respect to each other. The angle, B, can be in a range between about 3 degrees and about 7 degrees, or alternatively could be defined as imparting to each wall section 56, 58 a slope between about 1:20 and about 1:10. It should be understood and appreciated that, when being installed, the cutting head 16 initially will sit on the wall sections 56, 58 at a distance from the central floor portion 60 before the cutting head 16 is fully clamped within the pocket 54.

Referring back to FIG. 5, each wall section 56, 58 has a planar, torque transmission wall 66, a planar, vertically angled centering wall 68, and a blend 70 therebetween. The term “vertically angled” is defined as being formed at the non-zero angle, B (i.e. non-parallel) with respect to the central, longitudinal axis, A, of the cutting tool 10. The blends 70 located between walls 66, 68 provide a smooth transition between the walls 66, 68, thereby reducing stresses caused by the interference fit between the intermediate body 14 and the cutting head 16, and a reduction of stresses on the cutting tool 10 generated during machining operations. In the illustrated embodiment, the blends 70 have an arcuate profile. However, it will be appreciated that the blends 70 can have any desirable profile to reduce stresses by providing a break or relief between the wall 66, 68.

In the arrangement shown in FIGS. 5 and 6, the torque transmission walls 66 are oriented in parallel with respect to the central longitudinal axis, A, when viewed in a generally longitudinal direction. In at least one variant embodiment, the walls 66 may be inclined with respect to the central longitudinal axis, A, for example, at an angle of between about 0 degrees and about 10 degrees, and preferably between about 2 degrees and about 6 degrees. In one embodiment, the angle is approximately equal to the non-zero angle, B, of the centering wall 68 of each wall section 56, 58 in a direction opposite to the rotational cutting direction, C, of the intermediate body 14, toward the leading end of the base body 12.

Referring now to FIGS. 7-10, the cutting head 16 includes a generally cylindrical coupling pin 72 extending axially away from a main head portion 74 of the cutting head 16. A recess or notch 76 is provided in the coupling pin 72 to accommodate a setscrew 20. The notch 76 can be configured in any suitable manner, for example, in the illustrated embodiment, the notch 76 is defined by a relatively flat surface oriented in parallel to a chord or secant defined by the coupling pin 72 flanked on the two axial sides by angled surfaces, one per side, that converge on the flat surface from an external circumference defined by the coupling pin 72. The cutting head 16 also includes cutting edges 78, drive surfaces 80 and a cutting tip 82.

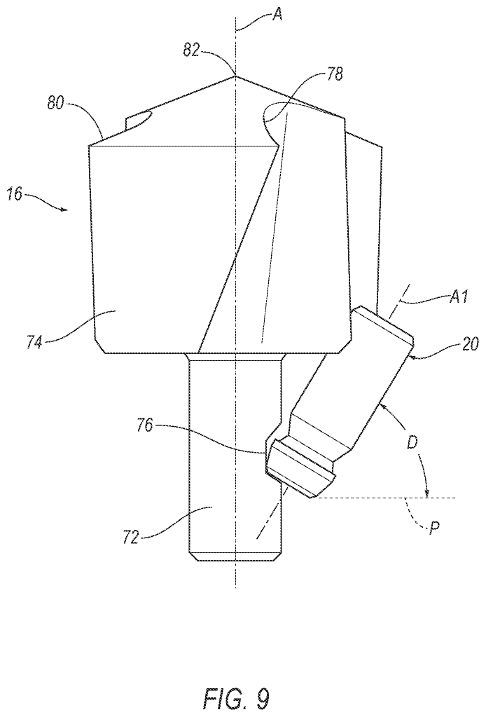

As shown in FIG. 9, the setscrew 20 may be inclined at an angle, D, with respect to a horizontal plane, P, (i.e., to a plane that is transverse to the central longitudinal axis, A), to engage the recess or notch 76. The setscrew 20 may be threadedly engaged in a compatible channel 84 (FIG. 6) in order to reciprocally translate along its own central longitudinal axis, A1. To this end, the setscrew 20 may be actuated at a rear portion thereof (i.e., at that end portion disposed away from the recess 76) by means of a wrench tool or other arrangement (not shown) that can linearly displace the setscrew 20 along its central longitudinal axis, A1.

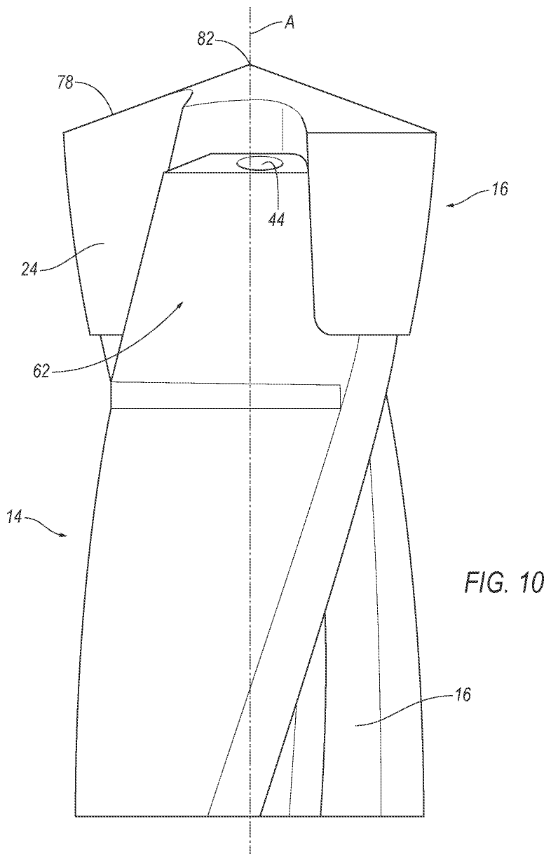

In one embodiment, the setscrew 20 is translated within the channel 84 to cause the setscrew 20 to move axially downwardly (i.e., toward the coupling pin 72). As a result of this downward movement, the setscrew 84 engages the notch 76 and then will cause the entire cutting head 16 to move axially downwardly in the pocket 54 of the intermediate body 14, whereupon the wall sections 56, 58 will elastically deform in a radially outward direction with respect to the central longitudinal axis, A. This will then promote an interference fit of the cutting head 16 within the intermediate body 14 such that the cutting head 16 is then securely clamped within the pocket 54 of the intermediate body 14, as shown in FIG. 10. It should be appreciated that a “bump-off” action takes place when the setscrew 20 undergoes a reverse translation movement and contacts the coupling pin 72 in such a way as to push the cutting head 16 out of the pocket 54 of the intermediate body 14.

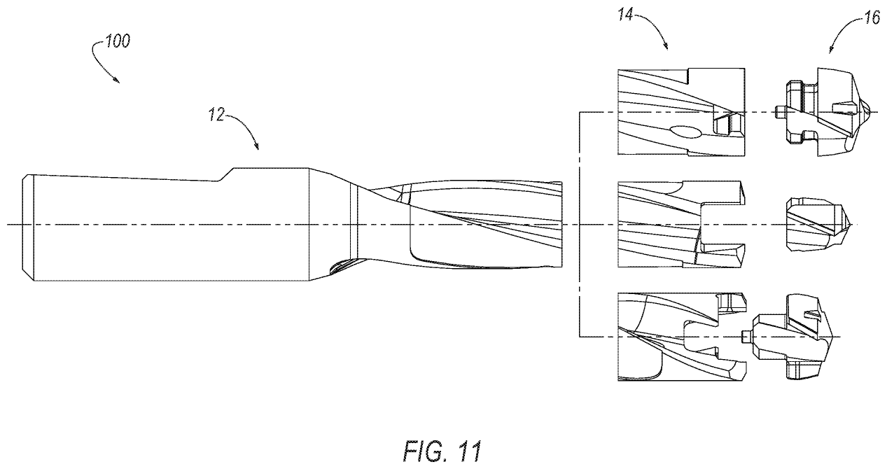

One aspect of the invention is that a desired combination of the base body 12, the intermediate body 14 and the cutting head 16 can be selected by the user in a tooling tree 100, as shown in FIG. 11. For example, the user can select the base body 12, the intermediate body 14 and the cutting head 16 based on the physical properties (i.e., intensive and extensive properties) of each of the base body 12, the intermediate body 14 and the cutting head 16. Examples of intensive properties include, but is not limited to, temperature, color, melting point, boiling point, and density. Examples of extensive properties includes, but is not limited to, length, shape, density, volume, and mass.

In the tooling tree 100 shown in FIG. 11, for example, the user may use a single base body 12 with a different intermediate body 14 to adapt to a different type of cutting head 16. In addition, the user may replace the base body 12, for example, made of steel, with a base body 12 made of carbide, thereby increasing the length, while increasing the stiffness of the cutting tool 10. Further, the tooling tree 100 allows the user to select different materials for the base body 12, the intermediate body 14 and the cutting head 16. For example, the base body 12 may be made of steel, while the intermediate body 14 and the cutting head 16 can be made of carbide. It should be appreciated that the invention is not limited by the examples of the tooling tree shown in FIG. 11, and that the principles of the invention can be practiced with any desirable combination of the base body 12, the intermediate body 14 and the cutting head 16 based on the physical properties of the base body 12, the intermediate body 14 and the cutting head 16. As described above, the tooling tree 100 allows a user the increased flexibility to select a different combination of the base body 12, the intermediate body 14 and the cutting head 16 of the cutting tool 10.

Having described presently preferred embodiments the disclosure may be otherwise embodied within the scope of the appended claims.

What is claimed is:

1. A modular cutting tool, comprising:
a base body;
an intermediate body removably attached to the base body portion; and
a cutting head at least partially disposed within a pocket of the intermediate body portion,
wherein a tooling tree allows a user to select a different combination of the base body, the intermediate body and the cutting head of the cutting tool.

2. The modular cutting tool of claim 1, wherein the different combination is selected by the user based on a physical property of the base body, the intermediate body and the cutting head.

3. The modular cutting tool of claim 1, further comprising a threaded fastener for removably attaching the intermediate body to the base body.

4. The modular cutting tool of claim 1, further comprising a setscrew for securing the cutting head to the intermediate body.

5. The modular cutting tool of claim 1, wherein the base body is made of a different material than the intermediate body.

6. The modular cutting tool of claim 1, wherein the intermediate body is made of a different material than the cutting head.

7. The modular cutting tool according to claim 1, wherein the cutting head is disposed within the pocket of the intermediate body using an interference fit.

8. The modular cutting tool according to claim 1, wherein the base body has one or more coolant holes that extend entirely from a trailing end of the base body to a leading end of the base body, and wherein the intermediate body has one or more coolant holes that extend entirely from a trailing end of the intermediate body to a leading end of the intermediate body, and wherein the one or more coolant holes of the base body are substantially aligned with the one or more coolant holes of the intermediate body when the intermediate body is removably attached to the base body.

9. The modular cutting tool according to claim 1, wherein the base body includes a raised boss having a threaded aperture for receiving a threaded fastener for removably attaching the intermediate body to the base body.

10. The modular cutting tool according to claim 9, wherein the threaded fastener has a threaded shaft portion and a non-threaded head portion having a relatively larger diameter than the threaded shaft portion.

11. The modular cutting tool according to claim 1, wherein the intermediate body includes a pair of downwardly extending ears formed on opposite sides of the intermediate body that cooperate with a pair of recesses formed on opposite sides in the base body.

12. The modular cutting tool according to claim 11, wherein each ear includes a threaded aperture for receiving a threaded fastener for removably attaching the intermediate body to the base body.
